(19) United States
(12) Patent Application Publication
(10) Pub. No.: US 2008/0314833 A1
(43) Pub. Date: Dec. 25, 2008

(54) COAGULANT DOSING PROCESS FOR MEMBRANE FILTRATION

(76) Inventors: Daniella Berenisse Mosqueda-Jimenez, Ontario (CA); Fraser Charles Kent, Ontario (CA); Andrew James Spring, Sackville (CA); Md Zamir Bin Alam, Scarborough (CA)

Correspondence Address: BERESKIN & PARR (MISSISSAUGA) / GE, SCOTIA PLAZA, 40 KING STREET WEST, 40TH FLOOR, TORONTO, ON, M6H-3V2, CA

(21) Appl. No.: 11/767,059

(22) Filed: Jun. 22, 2007

(51) Int. Cl. B01D 65/02

(52) U.S. Cl. 210/636

(57) ABSTRACT

A filtration process has a coagulation step and a membrane filtration step. The membrane filtration step has a permeation step followed by a cleaning step. In the coagulation step, a coagulant is added to feed water during a period of time beginning generally at the start of the permeation step and ending in a range from about 50% to 85% of the duration of the permeation step.

### FIELD

This specification relates to the field of membrane filtration.

### BACKGROUND

The following is not an admission that anything discussed below is prior art or part of the knowledge of persons skilled in the art or otherwise citable against the claims.

Coagulation involves adding a coagulant to water to interact with particulates, colloids or dissolved organic matter in the water. The coagulant typically provides or forms positively charged molecules in the feed water that react with negatively charged organic matter in the feed water to form aggregates, also called flocs. With for example aluminum or iron based coagulants, the coagulants may be added by flash mixing and initial coagulation reactions may occur in less than a minute. The flocs initially have a very small diameter, for example 0.01 microns or less, but aggregate to form larger flocs with time. The size of these flocs may be further increased in a separate flocculation step comprising low intensity mixing to a diameter of 0.1 mm or more, possibly up to a few mm. The term coagulation may refer to the initial step of mixing a coagulant with the feed water to form flocs where that is apparent from the context, but is more often used to refer more generally to any process of forming flocs in the feed water with the aid of a coagulant whether the process includes or does not include a separate flocculation step. The term flocculation may be used to refer to a separate step of aggregating flocs as described above where that meaning is apparent from the context, but may also be used to refer generally to a process of forming flocs in the feed water. The word flocculant is sometimes used to refer to a coagulant.

Through coagulation, particulates, colloids or dissolved organic matter in the water are bound up in the flocs. In a successful coagulation process, the flocs enable a downstream physical separation step to remove a higher percentage of particulates, colloids or dissolved organic matter by way of removing the flocs. U.S. Pat. No. 6,027,649 by Benedek at al., issued on Feb. 22, 2000, describes a process in which flocs are maintained in a mixed body of water containing a submerged membrane module. Permeate is removed from the body of water by applying a suction to a permeate side of the membrane module and the process is operated according to a process having generally continuous and simultaneous feed, reject removal and permeation. Coagulant is added to the body of water to produce flocs which are maintained within a desired concentration range in the body of water by balancing feed, coagulant addition, permeation and reject rates. In a presentation made to the 2003 AWWA Membrane Technology Conference in Atlanta, Ga. entitled “Simultaneous Oxidation-Coagulation Using Immersed Membranes for the Removal of Dissolved Organics and Iron and Manganese”, Singh et al. described a similar process used in a selection of pilot plants. In these plants, coagulants were added by injection into a feed line upstream of an inline flash mixer. The feed entered a first part of a tank having a paddle mixer and partitioned from a downstream second part of the tank containing a submerged membrane module. Feed addition, coagulant addition, permeation and reject removal were again generally continuous and simultaneous. Both of the publications described above are incorporated herein in their entirety by this reference to them.

Additional processes having coagulation and membrane separation steps are described in Japanese publication numbers 2004-321858; 2004-330,034; and, 2001-070,758.

### SUMMARY

The following summary is intended to introduce the reader to one or more inventions, which may be described in any part of this document, but the summary is not intended to define, narrow the meaning of, or add any limitation to any claim or any element or step of any claim.

A filtration process has a coagulation step and a membrane filtration step. The membrane filtration step has a permeation step followed by a cleaning step. In the coagulation step, a coagulant is added to feed water during a period of time beginning generally at the start of the permeation step and ending in a range from about 50% to 85% of the duration of the permeation step.

### BRIEF DESCRIPTION OF THE DRAWINGS

FIG. 1 is a schematic representation of a filtration system.

FIG. 2 is a graph showing TOC removal results in various experimental trials.

FIG. 3 is a graph showing fouling rate results in the experimental trials of FIG. 2.

### DETAILED DESCRIPTION

The following discussion will describe at least one example of a process or apparatus within each claim. However, a particular apparatus or process described below may not be within the bounds of a particular claim. The claims are not limited to apparatuses or processes having all of the features of any one or more examples described in this detailed description. A claim may read on processes or apparatuses not specifically described in this detailed description.

The inventors have observed that in water filtration systems, for example as used to produce drinking water or municipal or residential supply water, adding a coagulant to the feed water can produce an increased rate of removal of TOC. Coagulation may also produce a decrease in membrane fouling rate. However, a coagulant dosage rate that optimizes TOC removal is typically higher than a dosage rate that minimizes the fouling rate of the membranes and may instead increase the membrane-fouling rate. Further, a coagulant dosage rate that optimizes TOC removal may also add significant expenses in the form of the purchase price of the coagulants themselves, and also in the need to dispose of a sludge containing the flocs.

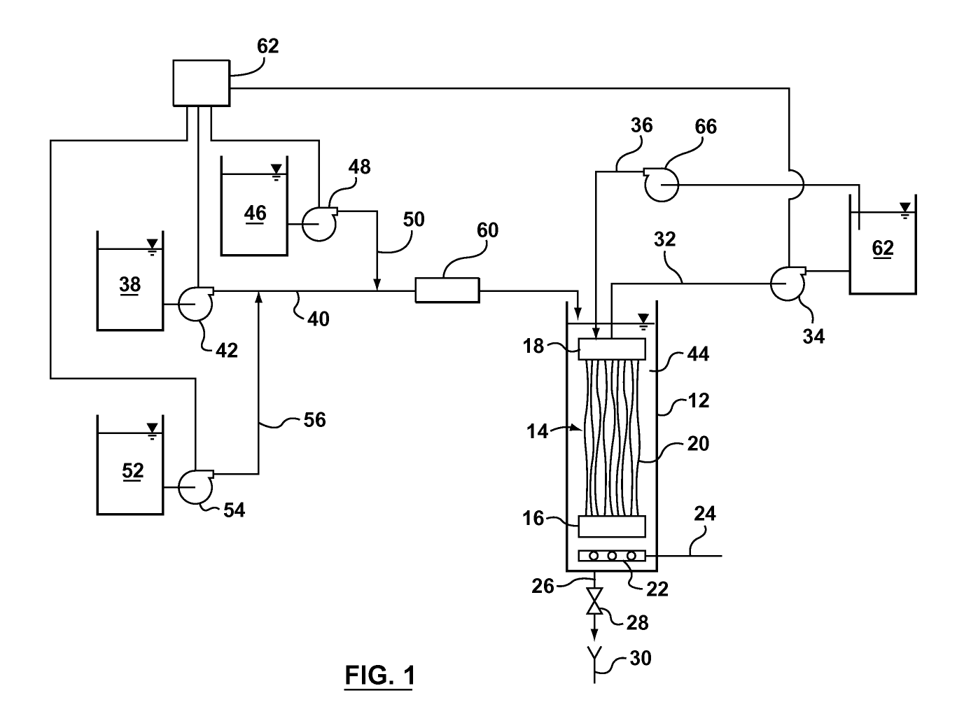

An example of a filtration system 10 that may be used to filter water is shown in FIG. 1. A vessel 12 has a membrane module 14 immersed in tank water 44 in the vessel 12. The membrane module 14 has a lower potting head 16, an upper potting head 18 and a set of hollow fiber membranes 20 suspended between them. An aerator 22 is located in the vessel 12 near the bottom of the module 14 and connected to an airline 24 to provide bubbles to scour the membranes 20 when desired. An outlet 26 of the vessel 12 has a valve 28 that may be opened to release water in the vessel 12 to a drain 30 when desired. A permeate pipe 32 connects a permeate cavity within the upper potting head 18 to a permeate pump 34. The permeate pipe 32 is in communication with the lumens of the membranes 20 through a permeate cavity within the upper potting head 18. When the permeate pump 34 is turned on a suction is created on the permeate sides of the membranes 20 to withdraw filtered water, or permeate, 62 through the walls of the membranes 20. Permeate 62 may be temporarily held in a permeate tank 64 until used or distributed. The membranes 20 may be backwashed when not permeating by forcing permeate 62, by way of a backwash pump 66, through a backwash line 36 attached from the permeate tank 64 to the upper potting head 18 and then out through the walls of the membranes 20.

Feed water 38 travels to the vessel 12 through a feed line 40 and is added to the tank water 44 when a feed pump 42 is turned on. After permeate 62 has been withdrawn, leaving solids or other contaminants rejected by the membranes 20 on the outsides of the membranes 20 or in an increased concentration in the tank water 44, the tank water 44 may be referred to as retentate or reject water. Coagulant 46 may flow under the force provided by a coagulant pump 48 through a coagulant line 50 to the feed line 40. A pH modifier 52, such as an acid or base, may flow by force of a pH modifier pump 54 through a pH modifier line 56 to the feed line 40 at a point upstream of the intersection with the coagulant line 50. A static mixer 60 is provided in the feed line 40 downstream of the intersection with the coagulant line 50 to mix coagulant 46 with the feed water 38. The pumps 34, 42, 48, and 54 are connected to a programmable logic controller (PLC) 62. The system 10 may be used to perform the process steps described below, although the steps may also be performed with other systems.

A water filtration process may have a step of membrane filtration followed by a step of membrane cleaning. These steps may be performed in repeated cycles. The cleaning step may be significantly shorter than the permeation step so that permeate is provided generally continuously.

The permeation step may include steps of feeding water to be filtered, or feed water 38, to a membrane module 14 and withdrawing filtered permeate through the walls of the membranes 20 of the module 14. The membrane module 14 may be kept in a tank or other vessel 12 and the feed water 38 may be fed to the membrane module 14 by introducing the feed water 38 into the vessel 12. Permeate 62 may be withdrawn by applying a suction to an interior, or permeate, side of the module 14 while the tank water 44 is maintained at ambient pressure. The permeation step may be generally in the form of dead end filtration wherein the rate and volume of permeate 62 removed during the permeation step generally equals the rate and volume of feed water 38 added during the permeation step. However, within dead end filtration, minor differences may occur between feed and permeate rates or volumes due to ancillary steps such as foam removal or due to temporary differences in feed and permeate rates at the beginning or end of a permeation step.

During the membrane cleaning step, permeation is stopped and one or more steps are performed to remove foulants that have accumulated on or in the membranes 20, or in the tank water 44, or both. One optional cleaning step is backwashing in which a fluid, such as a gas or permeate 62, is pushed through the membranes 20 in a reverse direction. Another optional cleaning step is deconcentration wherein tank water 44 rich in contaminants is replaced by fresh feed water 38, for example by draining the vessel 12 and refilling it with feed water 38. Another optional cleaning step is gas scouring in which bubbles are provided in the vessel 12, for example through aerator 22, and rise in the tank water 44 past the outsides of the membranes 20. Some other optional cleaning steps involve contacting the membranes 20 with cleaning chemicals. When one or more cleaning steps have been substantially completed, the process returns to the permeation step. Optionally a cleaning step, for example air scouring, may be performed while permeating. However a portion of a cleaning step performed while permeation is stopped is considered a membrane cleaning step performed following or after the permeation step even though another portion of the cleaning step is performed while permeating. The permeation step starts when permeation begins after a cleaning step, or portion of a cleaning step, performed while not permeating and ends when permeation stops before a subsequent cleaning step, or portion of a cleaning step, performed while not permeating.

During a coagulation step, coagulants 46 are added to the feed water 38. This may be done, for example, by way of mechanical mixers in a flash mix basin, mechanical in-line blenders or static mixers 60. A flash mix basin may have propeller or paddle type mixers and a residence time of about 10 seconds at maximum feed flow. An in-line blender may have a propeller mixer inside of a feed pipe. A static mixer 60 uses the energy of feed water flowing in a pipe to produce mixing against fix vanes. A static mixer 60 may be of a “cut and blend” type such as a multi element Sulzer/Koch™ or Statiflo™ mixer. With a static mixer 60, coagulant 46 chemicals are typically injected into the feed line 40 less than one second upstream of the static mixer 60. With all mixers, an effective amount of a pH modifier 52, such as an acid or base, may be injected into the feed line 40 at least 2 or 3 seconds upstream of the mixer to adjust pH to improve coagulation. The coagulant 46 may be, for example, aluminum sulfate (alum), ferric chloride, ferric sulfate or poly-aluminum chloride. Retention time in the feed line 40 may be short, for example less than 50 seconds, and yet allow sufficient floc aggregation. Optionally, the coagulation step may include a distinct flocculation step. The flocculation step may be provided by, for example, mechanical mixing, a baffled channel or air mixing.

Jar testing may be used to determine the dosing rate for the coagulant and any pH modifier. In jar testing, a sample of feed water is mixed with a coagulant and any pH modifier in a container such as a jar or beaker. Standard equipment such as a Phipps and Bird jar test apparatus may be used. Using that apparatus, one liter samples are held in jars and mixed at 300 rpm for less than 5 seconds while adding coagulant and pH adjusting chemicals. Mixing at 300 rpm continues until a total time of 30 seconds is reached, followed by mixing at 100 rpm for 15 minutes. One or more portions of the samples taken during or at the end of the 100 rpm mixing are sent through a test filter, for example a piece of membrane or 0.45 micron filter paper. One or more samples of feed without coagulant are also sent through the representative filter. The TOC concentrations of the filtrate from these samples are compared. The coagulant dosage that produces the maximum reduction in TOC is then converted into a coagulant dosing rate for the process. The dosing rate may be expressed as a mass of coagulant added per volume of feed water treated. Dosage rates may also be determined, or modified, based on piloting or actual process experience. The coagulant dosage rate may be chosen to provide an effective amount to meet a regulatory or design standard for removal of TOC or a related parameter. For example, the dosing rate may be effective to cause a reduction in TOC concentration in the permeate 62 of 25% or more relative to the TOC concentration in the feed water 38, or to increase the removal of TOC relative to a comparable process without coagulation by an amount equal to 10% or more of the TOC concentration of the feed water 38.

The coagulation step occurs during a first part of the permeation step. Coagulation may start before, on or shortly after the beginning of a permeation step. For example, if the vessel 12 holding the membrane module 14 has been drained, coagulation may begin when feed water 38 flow to re-fill the vessel 12 begins and continue after the permeate pump 34 is turned on to begin a permeation step. Coagulation further continues through an initial portion of the permeation step. For example, coagulation may end at a time in a range between and including about 50% to 85%, or between about 60% and 80%, of the duration of the permeation step from the start of the permeation step. The required flows of pH modifier 52, coagulant 46, permeate 62 and feed water 38 may be coordinated through a controller 62. For example, to re-fill the vessel 12 at the end of a cleaning step, the controller 62 may turn on feed pump 42, pH modifier pump 54 and coagulant pump 48. When the vessel 12 is full, controller 62 may turn permeate pump 34 on and simultaneously start an internal timer. When the timer indicates that the desired percentage of a predetermined permeation period has been reached, controller 62 turns pH modifier pump 54 and coagulant pump 34 off. Permeate pump 34 and feed pump 42 remain on until the end of the permeation period.

An experimental test was performed using a system similar to that shown in FIG. 1 except as described otherwise below. The system had five membrane filtration modules, each module having a set of polymeric, outside in hollow fiber membranes of the type used commercially on ZW 1000™ membrane units, but oriented vertically, providing a combined surface area of 1 square meter. The nominal pore size of the membranes was 0.04 microns. The modules were each provided in a separate vessel holding water at ambient pressure. The five vessels and modules were plumbed in parallel. The modules were driven, during permeation, by a suction pump controlled to produce a constant flux from each module of 30 gfd. The feed was surface water taken from Lake Ontario.

Experiments were performed with ferric chloride, alum (aluminum sulfate) and poly-aluminum chloride (PACl) at an equivalent molar concentration (of iron or aluminum) of 60 umol/L for all tests. This dosage, when used in combination with pH adjustment, was known from previous experience to cause a noticeable reduction in TOC and increase in fouling rate across a broad range of conditions and so was considered useful in that it would allow differentiation of both TOC removal and fouling rate between different test conditions. Each coagulant was added in-line by injection upstream of a static mixer. pH was adjusted by chemical addition upstream of the coagulant to a value that maximized organic matter removal in each trial. There was no separate flocculation step but only a section of tubing between the mixer and the membrane tank. Retention time, measured by the time required for the feed to flow between the mixer and the membranes tank, was less that 50 seconds. Floc size was not measured, but the inventors expect that the floc size was likely about 25 microns or less.

The trials involved a filtration process having repeated cycles, each cycle having a continuous 30 minute permeation step with no reject removal followed by a cleaning step in which permeation was stopped, the membranes were pre-aerated (air scoured) for 15 seconds, backpulsed with permeate while being aerated for another 15 seconds, and then the tank was drained completely and refilled. The tank drain and re-fill each took 45 seconds.

Coagulant addition was started while the tank was being refilled. Coagulant addition continued for, in various trials, 0, 50, 66.7, 83.3 or 100% of the permeation step, that is for 0, 15, 20, or 25 minutes respectively. After coagulant addition was stopped, membrane filtration continued without coagulation for the remainder of the permeation step. Each trial situation was repeated up to 5 times.

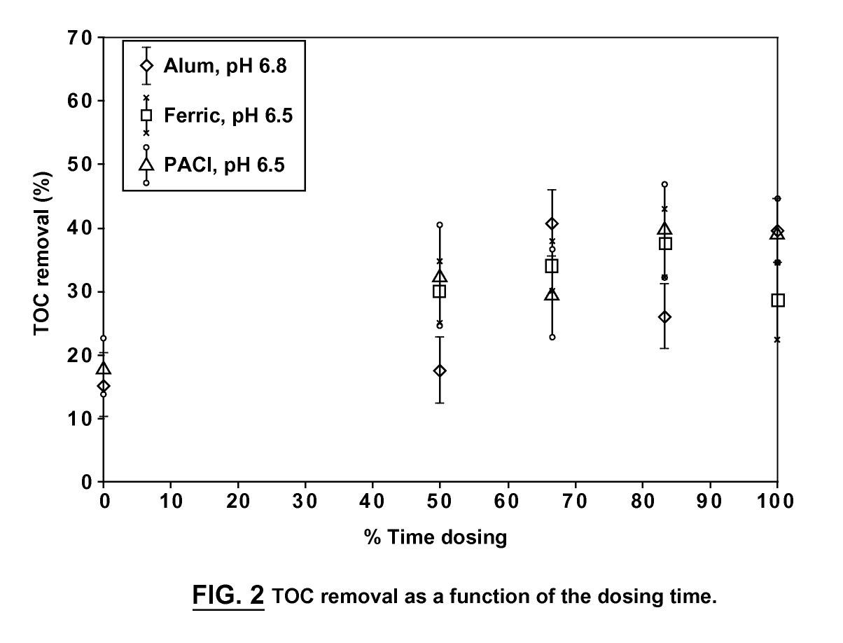

Permeate and feed samples were collected towards the end of the permeation cycles and the removal of organic carbon was calculated. These results are shown in FIG. 2. It can be observed that the amount of organic matter removed was generally similar regardless of the coagulant dosing time. However, under these test conditions, to achieve a significant increase in TOC removal using PACl, a coagulant duration longer than 50% of the permeation step was needed.

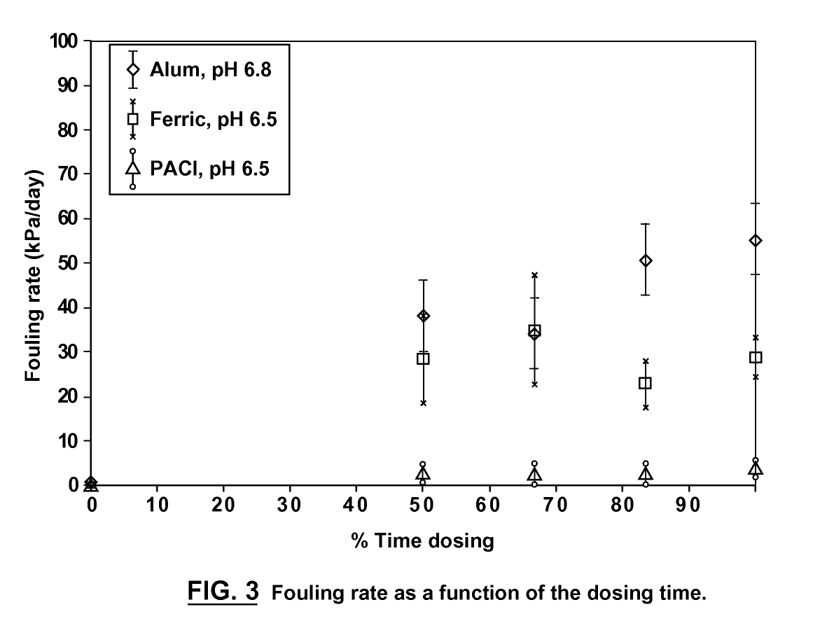

Membrane fouling rates were also calculated for each of the membrane modules operating under the different dosing conditions. These results are shown in FIG. 3. It can be observed that there was some variation of the fouling rates with coagulation duration but the fouling rates were generally similar.

In FIGS. 2 and 3, the horizontal tick marks above each data point show on standard deviation from the average value of the measured parameter. It can be observed that in many cases the test results are not statistically different to this standard as between tests at different coagulation durations within the measured range of durations. The test results thus demonstrate that under these conditions the filtration performance was not significantly reduced either in terms of membrane fouling rate or TOC removal when coagulation duration is restricted to the first 50% to 83% of the permeation step with all three coagulants and to the first 67% to 83% of the permeation step with PACl. These processes thus produce a savings in chemical and sludge removal costs without significant detriment. Coagulation durations in the range of about 60% to 80% or about 60% to 75% appear to produce stable results under a broad range of test conditions, and may even provide improvements in TOC or fouling rate under some test conditions. Implementation of the coagulation strategies may be done at low-cost using a coagulant dosing controller programmed to include a timer.

We claim:

1. A process for filtering a feed water comprising the steps of,
a) membrane filtration further comprising steps of,
i) permeation, wherein a filtered portion of the feed water is withdrawn through a membrane, followed by,
ii) membrane cleaning; and,
b) coagulation further comprising adding a coagulant to the feed water during a period of time beginning near the start of the permeation step and ending in a range from about 50% to 85% of the duration of the permeation step.

2. The process of claim 1 wherein the permeation step comprises a period of dead end filtration.

3. The process of claim 1 wherein the permeation step substantially consists of dead end filtration.

4. The process of claim 1 wherein the permeation and membrane cleaning steps are performed in repeated cycles.

5. The process of claim 1 wherein the coagulant is added to the feed water continuously during the coagulation step.

6. The process of claim 1 wherein the coagulation step begins generally at the same time as the start of the permeation step.

7. The process of claim 1 wherein the membrane cleaning step further comprises backwashing the membrane.

8. The process of claim 1 wherein the membrane is held in a vessel and the membrane cleaning step further comprises draining un-permeated feed water from the vessel.

9. The process of claim 7 wherein the membrane is held in a vessel and the membrane cleaning step further comprises draining un-permeated feed water from the vessel.

10. The process of claim 1 wherein the permeation step comprises applying a suction to an inside surface of the membrane.

11. The process of claim 10 wherein the period of time ends in a range from about 60% to 80% of the duration of the permeation step.

12. The process of claim 1 wherein the coagulant is PAC, alum or ferric chloride.

13. The process of claim 1 wherein the feed water is withdrawn during the permeation step at a generally constant flux.

14. The process of claim 1 wherein the coagulant is added at a generally constant rate per volume of water treated effective to produce a reduction in TOC concentration in the filtered water of 25% or more relative to the feed water.

15. The process of claim 1 wherein the coagulant is added at a generally constant dosing rate per volume of water treated effective to increase TOC removal, relative to a comparable process without a coagulation step, by an amount equal to 10% or more of the TOC concentration in the feed water.

16. A process for filtering feed water comprising the steps of,
a) dead end filtration, further comprising feeding the feed water to a membrane and withdrawing permeate through the membrane, for a first period of time;
b) mixing a coagulant into the feed water fed to the membrane during the second period of time, the second period of time having a duration of between about 50% and 85% of the first period of time, wherein the second period of time begins before, on or near the start of the first period of time but the duration of the second period of time is measured from the start of the first period of time; and,
c) after the first period of time, backwashing the membrane.

17. The process of claim 16 wherein the membrane is submerged in a vessel, the feed water is fed into a portion of the vessel outside of the membrane, and further comprising steps of draining the vessel of unfiltered feed water and refilling the vessel with feed water after the first period of time.

18. The process of claim 17 further comprising mixing a coagulant into the feed water while refilling the vessel.

19. The process of claim 16 wherein the second period of time has a duration measured from the start of the first period of time of between about 60% and 75% of the first period of time.

20. The process of claim 16 wherein permeate is withdrawn through the membrane by way of a suction applied to an inner surface of the membrane.
